(19) United States
(12) Patent Application Publication
(10) Pub. No.: US 2003/0101312 A1
(43) Pub. Date: May 29, 2003

(54) Machine state storage apparatus and method

(76) Inventors: Trung T. Doan, Boise, ID (US); Dean A. Klein, Eagle, ID (US)

Correspondence Address: Kimton N. Eng, Esq., DORSEY & WHITNEY LLP, 1420 Fifth Avenue, Suite 3400, Seattle, WA, 98101, US

(21) Appl. No.: 09/994,516

(22) Filed: Nov. 26, 2001

(51) Int. Cl. G06F 13/20

(52) U.S. Cl. 710/313

(57) ABSTRACT

An apparatus and method for capturing and restoring a machine state of a computer system. The apparatus includes a PC card having a non-volatile memory for storing machine state information corresponding to a machine state and a controller coupled to the nonvolatile memory to control the transfer of the machine state information to and from the nonvolatile memory. The apparatus further includes a transfer component for directing the controller to coordinate the storage and download of the machine state information in order to capture and restore a computer system to the stored machine state.

### TECHNICAL FIELD

The present invention relates to computer systems, and more particularly, to apparatus and methods for restoring a machine state of a computer system to enable relatively immediate operation upon restarting the computer system.

### BACKGROUND OF THE INVENTION

Computer systems have reached an impressive level of portability and computing power. However, despite the advances that have been made with respect to computer systems, there continues to be a desire to improve upon what is currently available. One area that has been the focus for improvement is with respect to the time necessary to start or restart a computer system from a powered-down state.

In a typical start-up process, the computer system performs various operations, each of which take time. These operations generally include a power-up sequence to check the system for operability, a review of main memory to determine the amount available and its operability, a system boot operation to load and execute basic system routines, and loading and executing of an operating system to prepare the computer system for use. In the case where the computer system is quite sophisticated, or the computer system has limited performance capabilities, the entire “cold boot” process may take quite some time to complete.

One approach to reducing the time it takes for a computer system to become usable is provided by way of a suspend mode. As an alternative to completely shutting down the computer system, which requires going through a full power-up and boot sequence, as well as, loading and executing the operating system when the system is restarted, a suspend mode allows a computer system to be restored to the machine or machine state at the time the suspend operation was performed. The various types of suspend modes have also been referred to as sleep modes, hibernate modes, and the like. In some cases, different levels of system activity or machine states are defined by the particular terminology. For example, in one suspend mode minimal power is continued to be supplied to the entire computer system, whereas in another suspend mode power is continued to be supplied to only certain parts of the computer system.

As is known in the art, a typical suspend operation utilizes a conventional hard disk for storing the relevant data to capture the machine state of a computer system before it is powered down. When the computer system is restarted, the machine state can be restored without the process of a cold boot by writing back the stored relevant data to the appropriate memory and register locations in the computer system. Thus, use of the computer system can be made available in considerably less time than if the computer system were restarted from a complete system shutdown.

Other approaches to the issues of power management and instant computer system availability include reduced boot sequences, maintaining various levels of system activity when the computer system is not in use, and designing hard disk drives with faster access and data transfer rates. Although the various approaches that have been taken in addressing the aforementioned issues have resulted in varying degrees of success, there is still a need for alternative approaches to reducing the time necessary to restart and restore a computer system to a usable machine state.

### SUMMARY OF THE INVENTION

Embodiments of the present invention are directed to an apparatus and method for capturing and restoring a machine state of a computer system having a central processing unit (CPU) coupled to a memory via a first bus, and further having a second bus coupled to the first bus to provide communication with the CPU and the memory. The apparatus includes a PC card coupled to the second bus and having a non-volatile memory for storing machine state information corresponding to the machine state. The PC card further has a controller coupled to the non-volatile memory to control the storing of data therein and the retrieval of data therefrom. The apparatus also includes a transfer component for directing the controller to coordinate with the CPU access to the nonvolatile memory and the memory to store and download the machine state information for capturing and restoring, respectively, a corresponding machine state of a computer system.

### BRIEF DESCRIPTION OF THE DRAWINGS

FIGS. 1a-c are block diagrams of computer systems in which embodiments of the present invention can be used.

FIG. 2 is a block diagram of a machine state memory card according to an embodiment of the present invention.

FIG. 3 is a flow diagram for storing a machine state of a computer system according to an embodiment of the present invention.

FIG. 4 is a flow diagram for restoring a computer system to a previously stored machine state according to an embodiment of the present invention.

### DETAILED DESCRIPTION OF THE INVENTION

Embodiments of the present invention provide an apparatus and method for storing and restoring a machine state of a computer system. In this manner, relatively immediate operation of the computer system upon power-up can be made available, thereby avoiding the need to wait for the typical power-up sequence and boot routine to complete. Certain details are set forth below to provide a sufficient understanding of the invention. However, it will be clear to one skilled in the art that the invention may be practiced without these particular details. In other instances, well-known circuits, control signals, timing protocols, and software operations have not been shown in detail in order to avoid unnecessarily obscuring the invention.

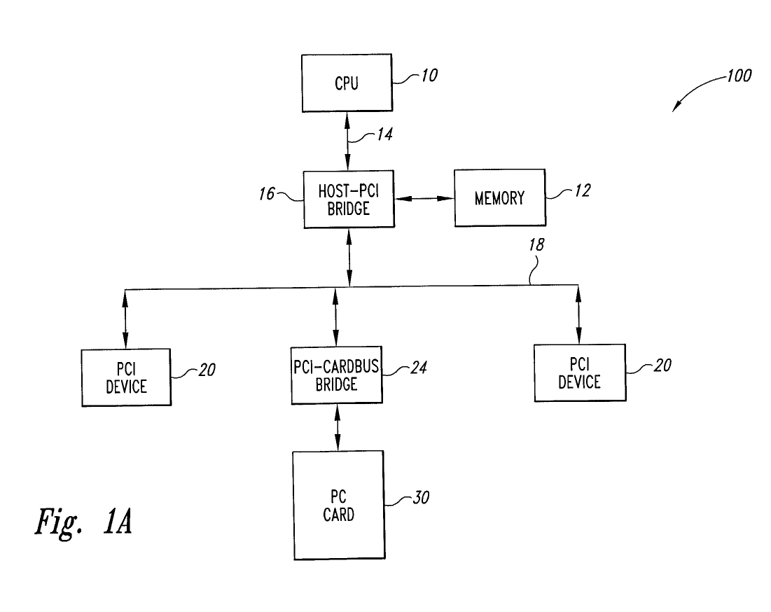

FIG. 1a illustrates an example of a computer system 100 in which embodiments of the present invention can be used. The computer system 100 includes a central processing unit (CPU) 10 coupled to a host-PCI bridge 16 through a local CPU bus 14. The host-PCI bridge 16 is also coupled to a memory 12 to provide the CPU 10 with access to the memory 12. As is well known in the art, the CPU 10 is capable of executing programmatic instructions stored in the memory 12. The CPU local bus 14 is coupled via a host-PCI bridge 16 to a PCI bus 18. The PCI bus 18 represents a relatively high-speed mezzanine bus through which a peripheral component or PCI device can be connected to the CPU 10 and memory 12. The host-PCI bridge 16 is delegated the responsibility of allocating the resources of the PCI bus 18 among the various PCI devices 20 competing for access thereto.

The PCI device 20 represents an example of the type of peripheral device that can be connected by the PCI bus 18 and the PCI bridge 16 to the CPU 10 and memory 12. The PCI device 20 can be a device compatible with the PCI protocol that is now known, or later developed. Examples of presently known PCI devices include a graphics processor, a sound card for driving audio speakers, and data storage devices such as hard disks and compact-disc drives. Further coupled to the PCI bus 18 is a PCI-CardBus bridge 24. The CardBus bridge 24 allows for a PC card 30 compatible with the CardBus standard to be connected to the PCI bus 18 and communicate with the CPU 10 and the memory 12. As is known, a CardBus enables data to be transferred between a PC card and computer system 100 at data transfer rates in excess of 100 MB/sec. The CardBus standard and protocol is well known in the art and will not be discussed in any greater detail herein for the sake of brevity.

As will be described in greater detail below, embodiments of the present invention are preferably implemented in the form of a PC card that can be connected with the computer system 100 through the PCI-CardBus bridge 24. As previously mentioned, the data transfer rates across the CardBus to the PCI bus 18 can exceed 100 MB/sec, thus, allowing for machine state load times upon system power-up to be in the range of a few seconds. In comparison, this represents a fraction of the load time for a typical hard-drive restore operation where the time to first access the hard-drive can be measured in tens of seconds.

As mentioned previously, FIG. 1a is merely illustrative of a computer system 100 in which embodiments of the present invention can be used. However, it will be appreciated that embodiments of the present invention can be used in a variety of different systems without departing from the scope of the present invention. FIG. 1b illustrates an alternative computer system 102 in which embodiments of the present invention can also be used. A memory hub controller (MCH) 116a is coupled to a CPU 110 through a CPU bus 114 and a memory 112 to provide access therebetween. The MCH 116a is further coupled to a graphics bus 115, such as an accelerated graphics port (AGP) to provide direct memory access (DMA) to the memory 112. A PCI bus 118 is coupled to the MCH 116a through a I/O hub controller (ICH) 116b and a communication bus 117, such as a HUBLINK bus, as is known in the art. Coupled to the PCI bus 118 is a PCI device 120, which, as previously mentioned, represents an example of the type of peripheral device that can be connected by the PCI bus 18 to the CPU 110 and memory 112. Further coupled to the PCI bus 118 is a PCI-CardBus bridge 124, which allows for a PC card 130 compatible with the CardBus standard to be connected to the PCI bus 118 and communicate with the CPU 110 and the memory 112.

FIG. 1c illustrates another computer system 150 in which embodiments of the present invention can be used. The computer systems 100 and 102 illustrated in FIGS. 1a and 1b, respectively, include a PCI bus 18 and 118 to which peripheral devices are coupled to the CPU and memory. However, embodiments of the present invention can be used in computer systems without a PCI bus, such as the computer system 150. A memory control-storage bridge 166 is coupled to a CPU 160 through a CPU bus 164, and farther coupled to a memory 162 to provide access therebetween. An I/O bus 168 is coupled to the memory control-storage bridge 166 to provide communication between input and output devices (not shown) and the CPU 160 and the memory 162. A non-volatile memory card 180 is also coupled to the memory control-storage bridge 166. In contrast to the computer systems of FIGS. 1a and 1b, communication between the memory card 180 and the CPU 160 and the memory 162 is made through the memory control-storage bridge 166, rather than through a PCI-CardBus bridge and a PCI bus. It will be appreciated that various storage interfaces, now known or later developed, can be used with the memory card 180 without departing from the scope of the present invention. For example, alternative storage interfaces that are currently known include MMC, Secure Digital, Memory Stick format, and the like.

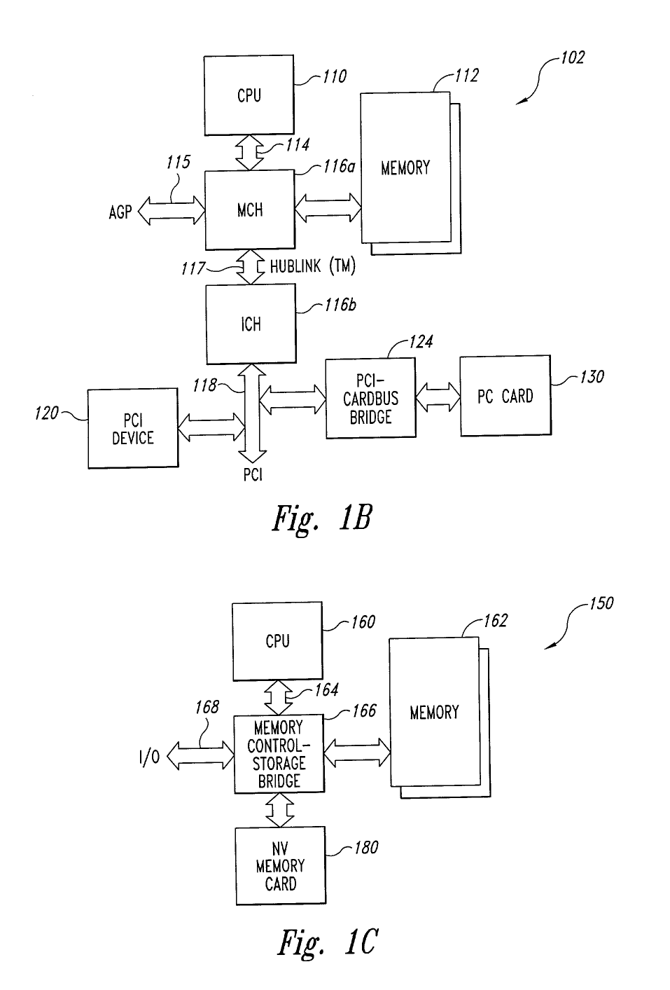

FIG. 2 illustrates a machine state memory card 200 according to an embodiment of the present invention. The machine state memory card 200 includes a connector 204 to which a bus interface 210 and a controller 212 are coupled. The connector 204 is a conventional connector through which the machine state memory card 200 can be connected to the PCI-CardBus bridge 24 and the PCI bus 18. Also included in the machine state memory card 200 is a memory 214 coupled to the bus interface 210 by a data bus 220 and further coupled to the controller 212 by control/address bus 224. The controller 212 coordinates the transfer of machine state information between the computer system 100 and the machine state memory card 200, and more particularly, to and from the memory 214, under the command of a transfer application 240. The transfer application 240 includes both a storing component 242 and a download component 244. It will be appreciated that the transfer application 240, although shown as included in the controller 212, can be divided such that other blocks of the machine state memory card 200 and the computer system 100 perform portions of the transfer application 240. For example, the CPU 10 can perform a detection function to determine if a machine state memory card 200 is connected to the computer system, and after the determination is made, the controller 212 can coordinate the transfer of the machine state information.

The memory 214 can be implemented using a conventional memory device, and preferably, a non-volatile memory device so that stored data will persist when power is not supplied. It will be appreciated that the bus interface 210 and the controller 212 can be designed using well known and conventional circuits, and that the description provided herein is sufficient to enable one of ordinary skill in the art to practice the invention. It will be further appreciated that the transfer application 240 may be implemented by either conventional software or hardware means, or a combination of both, and those of ordinary skill in the art will obtain a sufficient understanding of the present invention based on the description provided herein to practice the invention.

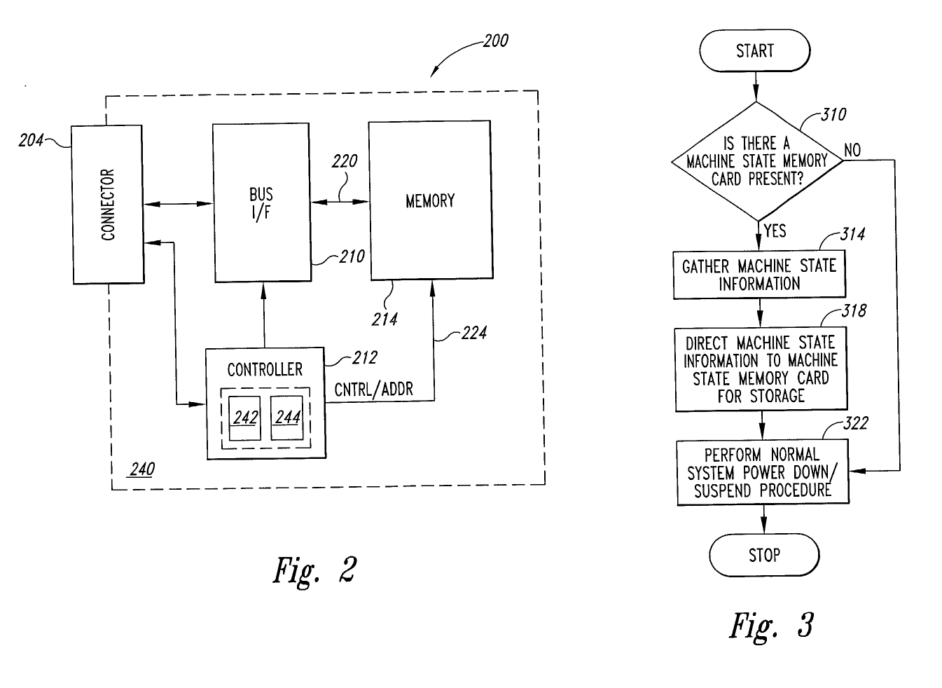

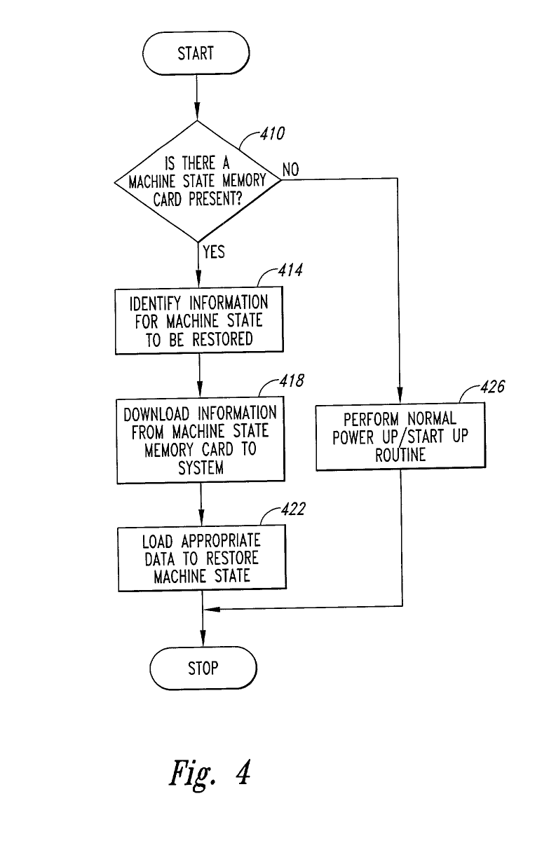

As will be described with respect to FIGS. 3 and 4, machine state information can be stored by the machine state memory card and subsequently downloaded to a computer system, such as the computer system 100 of FIG. 1a, in order to restore the computer system to the stored machine state. For example, the machine state memory card 200 can mirror the content of the computer system memory 12. Alternatively, the machine state information of the computer system can be stored by the machine state memory card 200 in a compressed data format, and then decompressed during downloading to the computer system to be restored. Suitable compression and decompression algorithms are known in the art, and consequently, will not be discussed herein in the interest of brevity.

An advantage provided by storing machine state information with the machine state memory card is the ability to store a machine state prior to shutting a computer system down, and then, restoring the computer system to the stored machine state upon powering-up the system using the PC state memory card 200. As a result, immediate operation of the computer system upon power-up is available, thereby avoiding the need to wait for a typical power-up sequence and boot routine to complete.

FIG. 3 illustrates a flow diagram for storing machine state information for a computer system according to an embodiment to the present invention. At a step 310, following a request for the storage operation of the machine state to be performed, the computer system 100 determines whether a machine state memory card 200 is connected through the PCI-CardBus bridge 24. Where a machine state memory card 200 is detected, the transfer application 240 is invoked and at a step 314 the machine state information is gathered and then directed to the machine state memory card 200 for storage at a step 318. One example of when the machine state storage operation can be performed is in response to a computer system shutdown or suspend operation. One of ordinary skill in the art will appreciate that the power management code in the BIOS of a computer system will need to be modified to initiate the operation. The modification required to carry out this operation is well within the skill of those familiar in the art. It will be further appreciated that initiation of the machine state storage process can be made in response to other events as well. Moreover, the machine state storage process can be invoked automatically in response to an event, or can be invoked upon a user request.

The controller 212 negotiates with the host-PCI bridge 16 to obtain control of the PCI bus 18, and subsequently directs the transfer of the machine state information from the computer system 100 to the memory 214 of the machine state memory card 200. The controller 212 coordinates the transfer of the machine state information through the bus interface 210 and stores the machine state information in the memory 214 in a format such that upon restoring a machine state stored by the machine state memory card 200 the information will be downloaded to a computer system 100 accordingly.

Upon completing storage of the machine state, the controller 212 relinquishes control of the PCI bus 18 and allows the computer system 100 to resume normal operation. As illustrated in FIG. 3, at a step 322, a normal power-down or suspend procedure is performed. Performance of step 322 assumes that the request for storing the machine state of the computer system 100 was made in response to a system shutdown or suspend operation. It will be appreciated that step 322 provides a specific example of the type of normal operation that is resumed following the storage of the machine state in the machine state memory card 200. However, the particular type of operation that is performed is a detail that can be modified without deviating from the scope of the present invention.

FIG. 4 illustrates an embodiment in accordance with the present invention of an operation to restore a machine state to a computer system to which the machine state memory card 200 is connected. In the present example, the restoration operation will be described with respect to the computer system 100 of FIG. 1a. Typically, the operation illustrated in FIG. 4 is performed in order to provide relatively instant operation of the computer system 100 upon power-up. More generally, however, the operation may be performed whenever restoration of a machine state stored by the machine state memory card 200 is desired.

At a step 410, the computer system 100 determines whether a machine state memory card 200 is connected to the PCI-CardBus bridge 24. If detected, the transfer application 240 is invoked. The transfer application 240 identifies the machine state information for restoring a machine state at a step 414, and instructs the controller 212 to retrieve the appropriate machine state information from the memory 214 and transfer the data through the bus interface 210 to the computer system 100 at a step 418. The controller 212 negotiates with the PCI bridge 16 to obtain control of the PCI bus 18, and subsequently coordinates the transfer of the machine state information with the CPU 10 and/or the host-PCI bridge 16 to write the appropriate information in order to restore the machine state at a step 422. For example, the data present in the memory 12 at the time the selected machine state was stored in the machine state memory card 200 is rewritten to the memory 12 upon the restoration operation. Similarly, the data present in the various data registers of the CPU 10, and more generally, throughout the computer system 100, are rewritten to restore the machine state. When download of the machine state information is completed, the controller 212 relinquishes control of the PCI bus and normal computer system operation is resumed.

It will be appreciated that transfer of the machine state information from the machine state memory card 200 to a computer system can occur in a variety of manners without departing from the scope of the present invention. For example, it was previously described that transfer of the machine state information is initiated and continues until completed. However, alternatively, the machine state can be transferred to a computer system in bursts that occur in several segments. Modifications to accommodate this type of data transfer is well within the understanding of those of ordinary skill in the art.

Additionally, as previously mentioned, the machine state information stored by the machine state memory card 200 may be stored in a compressed format. Consequently, upon transferring the machine state information to the computer system 100, decompression of the machine state information may be necessary. As also mentioned previously, suitable compression and decompression algorithms are known in the art.

With the machine state information provided by the machine state memory card 200 and written to appropriate memory and register locations, the computer system 100 can resume its operation from the machine state at the time the machine state information had been previously stored. As previously mentioned, this ability to restore a computer system to a previous machine state provides many benefits. In one application, the restoration of a previous machine state allows for nearly immediate operation of a computer system upon power-up because the typical power-up sequence and boot routine can be bypassed. In another application, a user can transport the user's machine state between similar computer systems to provide portability.

In an alternative embodiment of the present invention, the machine state memory card 200 can be modified to store multiple machine states. That is, different machine states, for different machines or for different known machine states, can be stored in the memory 214. The transfer application 240 can be modified to prompt a user to identify a particular machine state upon storing and downloading of a machine state to a computer system. File management of this type is well known in the art and can be incorporated into the transfer application 240 by one of ordinary skill in the art without difficulty. This embodiment may be used by system administrators to store various known machine states for the purposes of trouble-shooting, or to recover a computer system from a system crash or the like.

It will be appreciated that some or all of the principles of the present invention can be applied to many different applications, and those expressly described herein do not represent a comprehensive list of possible applications. Consequently, the particular application of the present invention should not be interpreted as limiting the scope of the present invention except to the extent such limitation is recited in one of the claims appended hereto.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A computer system, comprising:
a central processing unit (CPU);
a first bus coupled to the CPU;
a memory coupled to the first bus to store data accessible by the CPU via the first bus;
a second bus coupled to the first bus to provide communication with the CPU and the memory via the first bus; and
a PC card coupled to the second bus, the PC card having a non-volatile memory for storing machine state information and further having a controller coupled to the non-volatile memory for coordinating with the CPU access to the non-volatile memory and the memory to store and download the machine state information for capturing and restoring, respectively, a corresponding machine state of a computer system.

2. The computer system of claim 1 wherein the first bus comprises a local CPU bus and the second bus comprises a PCI bus.

3. The computer system of claim 2, further comprising a PCI-CardBus bridge coupled to the PCI bus to provide communication between the PCI bus and a CardBus compatible device coupled to the PCI-CardBus bridge.

4. The computer system of claim 1 wherein the non-volatile memory of the PC card comprises a flash memory device.

5. The computer system of claim 1 wherein the PC card further includes a bus interface coupled to the second bus, and further coupled to the non-volatile memory and the controller to transfer data between the memory and the second bus in accordance with a data format and transfer protocol of the second bus.

6. The computer system of claim 1, further comprising a transfer component directing the controller to coordinate access between the non-volatile memory and the memory to transfer machine state information.

7. The computer system of claim 1, further comprising compression and decompression components for compressing the machine state information to be stored and decompressing the stored compressed machine state information to be downloaded, respectively.

8. The computer system of claim 1 wherein the machine state information comprises data from the memory and CPU for returning the computer system to the same condition of operability as when the machine state information was stored in the non-volatile memory.

9. A computer system, comprising:
a central processing unit (CPU);
a memory coupled to the CPU to store data accessible by the CPU;
a bus coupled to the CPU and memory to provide communication therewith; and
a PC card coupled to the bus, the PC card having a non-volatile memory for storing machine state information and further having a controller coupled to the non-volatile memory for coordinating with the CPU access to the non-volatile memory and the memory to store and download the machine state information for capturing and restoring, respectively, a corresponding machine state of a computer system.

10. The computer system of claim 9 wherein the bus comprises a PCI bus, and the computer system further comprises a PCI-CardBus bridge coupled to the PCI bus to provide communication between the PCI bus and a CardBus compatible device coupled to the PCI-CardBus bridge.

11. The computer system of claim 9 wherein the non-volatile memory of the PC card comprises a flash memory device.

12. The computer system of claim 9 wherein the PC card further includes a bus interface coupled to the bus, and further coupled to the non-volatile memory and the controller to transfer data between the memory and the bus in accordance with a data format and transfer protocol of the bus.

13. The computer system of claim 9, further comprising a transfer component directing the controller to coordinate access between the non-volatile memory and the memory to transfer machine state information.

14. The computer system of claim 9, further comprising compression and decompression components for compressing the machine state information to be stored and decompressing the stored compressed machine state information to be downloaded, respectively.

15. The computer system of claim 9 wherein the machine state information comprises data from the memory and CPU for returning the computer system to the same condition of operability as when the machine state information was stored in the non-volatile memory.

16. An apparatus for capturing and restoring a machine state of a computer system having a central processing unit (CPU) coupled to a memory via a first bus, and further having a second bus coupled to the first bus to provide communication with the CPU and the memory, the apparatus comprising:
a PC card coupled to the second bus, the PC card having a non-volatile memory for storing machine state information corresponding to the machine state, and further having a controller coupled to the non-volatile memory to control the storing of data therein and the retrieval of data therefrom; and
a transfer component for directing the controller to coordinate with the CPU access to the non-volatile memory and the memory to store and download the machine state information for capturing and restoring, respectively, a corresponding machine state of a computer system.

17. The apparatus of claim 16, further comprising a bus interface coupled to the second bus, and further coupled to the non-volatile memory and the controller to transfer data between the memory and the second bus in accordance with a data format and transfer protocol of the second bus.

18. The apparatus of claim 17 wherein the second bus is a PCI bus and the bus interface is CardBus compatible.

19. The apparatus of claim 16 wherein the non-volatile memory comprises a flash memory.

20. The apparatus of claim 16 wherein the transfer component comprises:
a storing component for directing the controller to store machine state information from the CPU and memory to the non-volatile memory; and
a download component for directing the controller to transfer data from the nonvolatile memory to the CPU and the memory.

21. The apparatus of claim 16, further comprising compression and decompression components for compressing the machine state information to be stored and decompressing the stored compressed machine state information to be downloaded, respectively.

22. An apparatus for capturing and restoring a machine state of a computer system having a central processing unit (CPU) coupled to a memory, and further having a bus coupled to the CPU and memory to provide communication with the CPU and the memory, the apparatus comprising:
a PC card coupled to the bus, the PC card having a non-volatile memory for storing machine state information corresponding to the machine state, and further having a controller coupled to the non-volatile memory to control the storing of data therein and the retrieval of data therefrom; and
a transfer component for directing the controller to coordinate with the CPU access to the non-volatile memory and the memory to store and download the machine state information for capturing and restoring, respectively, a corresponding machine state of a computer system.

23. The apparatus of claim 22, further comprising a bus interface coupled to the bus, and further coupled to the non-volatile memory and the controller to transfer data between the memory and the bus in accordance with a data format and transfer protocol of the bus.

24. The apparatus of claim 23 wherein the bus is a PCI bus and the bus interface is CardBus compatible.

25. The apparatus of claim 23 wherein the non-volatile memory comprises a flash memory.

26. The apparatus of claim 23 wherein the transfer component comprises:
a storing component for directing the controller to store machine state information from the CPU and memory to the non-volatile memory; and
a download component for directing the controller to transfer data from the nonvolatile memory to the CPU and the memory.

27. The apparatus of claim 23, further comprising compression and decompression components for compressing the machine state information to be stored and decompressing the stored compressed machine state information to be downloaded, respectively.

28. An CardBus compatible PC card for restoring a machine state of a computer system having a central processing unit (CPU) coupled to a memory via a CPU bus, and further having a PCI bus coupled to the CPU bus to provide communication with the CPU and the memory, the PC card comprising:
an interface coupled to the PCI bus for transferring data thereto and therefrom;
a non-volatile memory coupled to the interface for storing and providing machine state information corresponding to the machine state;
a controller coupled to the interface and non-volatile memory to control the storing of machine state information in the non-volatile memory and the retrieval of the machine state information from the non-volatile memory; and
a transfer component for directing the controller to coordinate with the CPU access to the non-volatile memory and the memory to store and download the machine state information for capturing and restoring, respectively, a corresponding machine state of a computer system.

29. The PC card of claim 28 wherein the machine state information comprises data from the memory and CPU for returning the computer system to the same condition of operability as when the machine state information was stored in the non-volatile memory.

30. The PC card of claim 28 wherein the non-volatile memory comprises a flash memory device.

31. The PC card of claim 28 wherein the transfer component comprises:
a storing component for directing the controller to store machine state information from the CPU and memory to the non-volatile memory; and
a download component for directing the controller to transfer data from the nonvolatile memory to the CPU and the memory.

32. The PC card of claim 28, further comprising compression and decompression components for compressing the machine state information to be stored in the non-volatile memory and decompressing the stored compressed machine state information to be downloaded, respectively.

33. A computer system, comprising:
a central processing unit (CPU);
a local CPU bus coupled to the CPU;
a memory coupled the local CPU bus to store data accessible by the CPU via the local CPU bus;
a PCI bus coupled to the local CPU bus to provide communication with the CPU and the memory via the local CPU bus;
a PCI-CardBus bridge coupled to the PCI bus to provide communication between the PCI bus and a CardBus compatible device;
a CardBus compatible PC card coupled to PCI-CardBus bridge, the PC card having a non-volatile memory for storing machine state information corresponding to the machine state, and further having a controller coupled to the non-volatile memory to control the storing of data therein and the retrieval of data therefrom; and
a transfer component for directing the controller to coordinate with the CPU access to the non-volatile memory and the memory to store and download the machine state information for capturing and restoring, respectively, a corresponding machine state of a computer system.

34. The computer system of claim 33 wherein the non-volatile memory of the PC card comprises a flash memory device.

35. The computer system of claim 33 wherein the PC card further includes a bus interface coupled to the PCI bus, and further coupled to the non-volatile memory and the controller to transfer data between the memory and the PCI bus in accordance with the PCI data format and transfer protocol.

36. The computer system of claim 33, further comprising compression and decompression components for compressing the machine state information to be stored in the non-volatile memory and decompressing the stored compressed machine state information to be downloaded, respectively.

37. The computer system of claim 33 wherein the machine state information comprises data from the memory and CPU for returning the computer system to the same condition of operability as when the machine state information was stored in the non-volatile memory.

38. In a computer system having a central processing unit (CPU) coupled to a memory, and further having a bus coupled to the CPU and memory to provide communication therewith, a method for storing a machine state of the computer system, comprising:
capturing the machine state of the computer system;
transferring machine state information corresponding to the captured machine state from the computer system to a PC card having a non-volatile memory; and
storing the machine state information in the non-volatile memory in order to restore the stored machine state when the machine state information is provided to a computer system.

39. The method of claim 38 wherein capturing, transferring and storing the machine state information is in response to executing a power down procedure.

40. The method of claim 38 wherein capturing, transferring and storing the machine state information is in response to a user request.

41. The method of claim 38 wherein the machine state information comprises data from the memory and CPU for returning the computer system to the same condition of operability as when the machine state information was stored in the non-volatile memory.

42. The method of claim 38 wherein capturing the machine state of the computer system comprises:
capturing data present in the memory; and
capturing data present in registers of the CPU.

43. The method of claim 38 wherein transferring the machine state information to the PC card comprises transferring data from the CPU and the memory to the PC card in accordance with a CardBus protocol.

44. The method of claim 38, further comprising compressing the machine state information to be stored in the non-volatile memory.

45. A method for restoring a machine state to a computer system having a central processing unit (CPU) coupled to a memory, and further having a bus coupled to the CPU and memory to provide communication therewith, the method comprising:
identifying machine state information corresponding to the machine state to which the computer system is to be restored stored in a non-volatile memory included in a PC card;
transferring the machine state information from the non-volatile memory to the computer system; and
writing data of the machine state information to the memory and CPU in order to restore the computer system to the identified machine state.

46. The method of claim 45 wherein identifying, transferring and writing the machine state information is in response to executing a power up procedure.

47. The method of claim 45 wherein identifying, transferring and writing the machine state information is in response to user request.

48. The method of claim 45 wherein the machine state information comprises data from the memory and CPU for returning the computer system to the same condition of operability as when the machine state information was stored in the non-volatile memory.

49. The method of claim 45 wherein transferring the machine state information from the non-volatile memory comprises transferring data from PC card to the computer system in accordance with a CardBus protocol.

50. The method of claim 45 wherein the machine state information stored in the non-volatile memory is in a compressed data format, and the method further comprises decompressing the machine state information to be transferred to the computer system.
